(19) United States
(12) Patent Application Publication
(10) Pub. No.: US 2005/0261151 A1
(43) Pub. Date: Nov. 24, 2005

(54) Corrosion-inhibiting cleaning compositions for metal layers and patterns on semiconductor substrates

(76) Inventors: Kwang-Wook Lee, Gyeonggi-do (KR); In-Seak Hwang, Gyeonggi-do (KR); Keum-Joo Lee, Gyeonggi-do (KR); Chang-Lyong Song, Gyeonggi-do (KR); Yong-Sun Ko, Gyeonggi-do (KR); Kui-Jong Baek, Daejeon-si (KR); Woong Han, Chungcheongnam-do (KR)

Correspondence Address: MYERS BIGEL SIBLEY & SAJOVEC, PO BOX 37428, RALEIGH, NC, 27627, US

(21) Appl. No.: 11/030,258

(22) Filed: Jan. 6, 2005

(30) Foreign Application Priority Data
May 19, 2004 (KR) 2004-35495

(51) Int. Cl. C11D 1/00

(52) U.S. Cl. 510/175

(57) ABSTRACT

A corrosion-inhibiting cleaning composition for semiconductor wafer processing includes hydrogen peroxide at a concentration in a range from about 0.5 wt % to about 5 wt %, sulfuric acid at a concentration in a range from about 1 wt % to about 10 wt %, hydrogen fluoride at a concentration in a range from about 0.01 wt % to about 1 wt %; an azole at a concentration in a range from about 0.1 wt % to about 5 wt % and deionized water. The azole operates to inhibit corrosion of a metal layer being cleaned by chelating with a surface of the metal layer during a cleaning process.

### CROSS REFERENCE TO RELATED APPLICATION

This application is related to U.S. application Ser. No. ______, filed Dec. 23, 2004, entitled Corrosion-Inhibiting Cleaning Compositions for Metal Layers and Patterns on Semiconductor Substrates (Attorney Docket No. 5649-1361).

### REFERENCE TO PRIORITY APPLICATION

This application claims priority to Korean Application Serial No. 2004-35495, filed May 19, 2004, the disclosure of which is hereby incorporated herein by reference.

### FIELD OF THE INVENTION

The present invention relates to methods of forming integrated circuit devices and, more particularly, to methods of cleaning and polishing metal layers on integrated circuit substrates.

### BACKGROUND OF THE INVENTION

Integrated circuit chips frequently utilize multiple levels of patterned metallization and conductive plugs to provide electrical interconnects between active devices within a semiconductor substrate. To achieve low resistance interconnects, tungsten metal layers have been deposited and patterned as electrodes (e.g., gate electrodes), conductive plugs and metal wiring layers. The processing of tungsten and other metal layers frequently requires the use of cleaning compositions to remove polymer and other residues from the metal layers. Such residues may remain after conventional processing steps such as resist ashing. Unfortunately, the use of cleaning compositions that remove residues from metal layers may lead to metal layer corrosion from chemical etchants.

Cleaning compositions configured to inhibit metal corrosion during semiconductor wafer processing have been developed. One such cleaning composition is disclosed in U.S. Pat. No. 6,117,795 to Pasch. This cleaning composition includes using a corrosion inhibiting compound, such as an azole compound, during post-etch cleaning. Corrosion inhibiting compounds may also be used to inhibit corrosion of metal patterns during chemical-mechanical polishing (CMP). Such compounds, which include at least one of sulfur containing compounds, phosphorus containing compounds and azoles, are disclosed in U.S. Pat. Nos. 6,068,879 and 6,383,414 to Pasch. U.S. Pat. No. 6,482,750 to Yokoi also discloses corrosion inhibiting compounds that are suitable for processing tungsten metal layers and U.S. Pat. No. 6,194,366 to Naghshineh et al. discloses corrosion inhibiting compounds that are suitable for processing copper containing microelectronic substrates. Notwithstanding these cleaning and corrosion-inhibiting compositions for semiconductor wafer processing, there continues to be a need for compositions having enhanced cleaning and corrosion-inhibiting characteristics.

### SUMMARY OF THE INVENTION

Embodiments of the present invention include corrosion-inhibiting cleaning compositions for semiconductor wafer processing. These compositions include an aqueous admixture of at least one metal etchant, first and second different oxide etchants, an azole and water. The azole acts as a chelating agent that binds with and inhibits corrosion of metal layers being cleaned. The azole may be selected from a group consisting of triazole, benzotriazole, imidazole, tetrazole, thiazole, oxazole and pyrazole and combinations thereof. More preferably, the azole is either triazole, benzotriazole or imidazole. A quantity of the azole in the aqueous admixture is in a range from about 0.1 wt % to about 5 wt %.

In additional embodiments of the invention, the first oxide etchant is sulfuric acid, the second oxide etchant is a fluoride and the metal etchant is hydrogen peroxide. A quantity of the metal etchant in the aqueous admixture is in a range from about 0.5 wt % to about 5 wt %. This level of metal etchant is sufficient to have good metal polymer removal rate but not too high to provide metal layer over-etch. A quantity of the sulfuric acid in the aqueous admixture may also be set within a range from about 1 wt % to about 10 wt % and a quantity of the fluoride in the aqueous admixture may be set within a range from about 0.01 wt % to about 1 wt %.

Additional embodiments of the invention include a corrosion-inhibiting cleaning solution that consists essentially of a metal etchant, first and second oxide etchants, a metal chelating agent and water. In these embodiments, the metal etchant can be hydrogen peroxide at a concentration in a range from about 0.5 wt % to about 5 wt % and the first oxide etchant can be sulfuric acid at a concentration in a range from about 1 wt % to about 10 wt %. The second oxide etchant can be hydrogen fluoride at a concentration in a range from about 0.01 wt % to about 1 wt % and the metal chelating agent can be an azole at a concentration in a range from about 0.1 wt % to about 5 wt %.

Still further embodiments of the invention include methods of forming integrated circuit devices by forming a gate oxide layer on an integrated circuit substrate and forming a tungsten metal layer on the gate oxide layer. The tungsten metal layer and the gate oxide layer are patterned to define a tungsten-based insulated gate electrode. The patterned tungsten metal layer is exposed to a cleaning solution containing a metal etchant, at least first and second oxide etchants, a corrosion-inhibiting azole and deionized water. The metal etchant can be a peroxide, the first oxide etchant can be sulfuric acid and the second oxide etchant can be hydrogen fluoride. Methods of forming integrated circuit devices also include methods of forming memory devices by forming an interlayer dielectric layer on an integrated circuit substrate and forming an interconnect opening in the interlayer dielectric layer. The interconnect opening is filled with a conductive plug and then a bit line node is formed on the conductive plug. The bit line node is exposed to a cleaning solution including a metal etchant, at least first and second oxide etchants, a corrosion-inhibiting azole and deionized water.

### BRIEF DESCRIPTION OF THE DRAWINGS

FIGS. 1A-1D are cross-sectional views of intermediate structures that illustrate methods of cleaning metal layers on semiconductor substrates according to embodiments of the present invention.

FIGS. 2A-2F are cross-sectional views of intermediate structures that illustrate methods of cleaning metal layers on semiconductor substrates according to additional embodiments of the present invention.

### DETAILED DESCRIPTION OF PREFERRED EMBODIMENTS

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

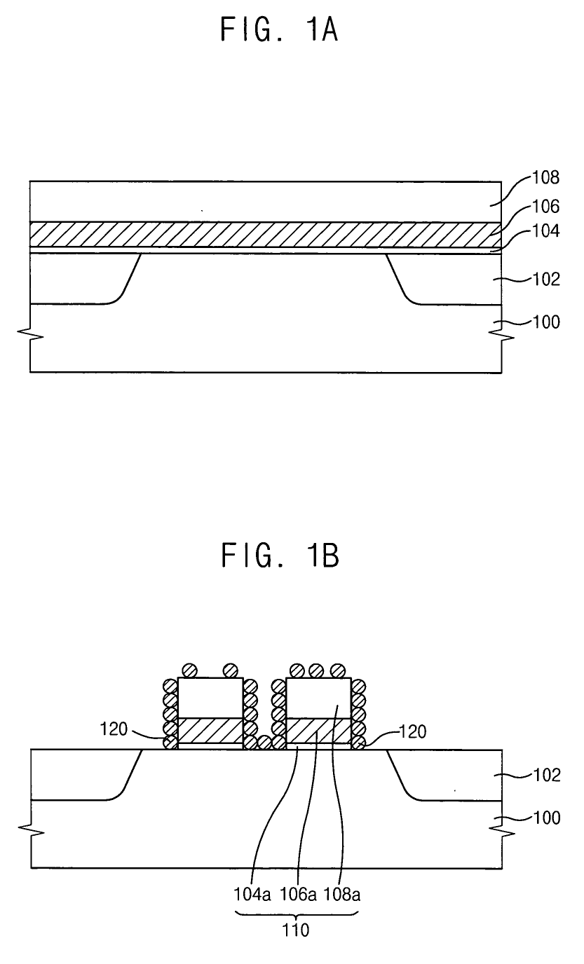

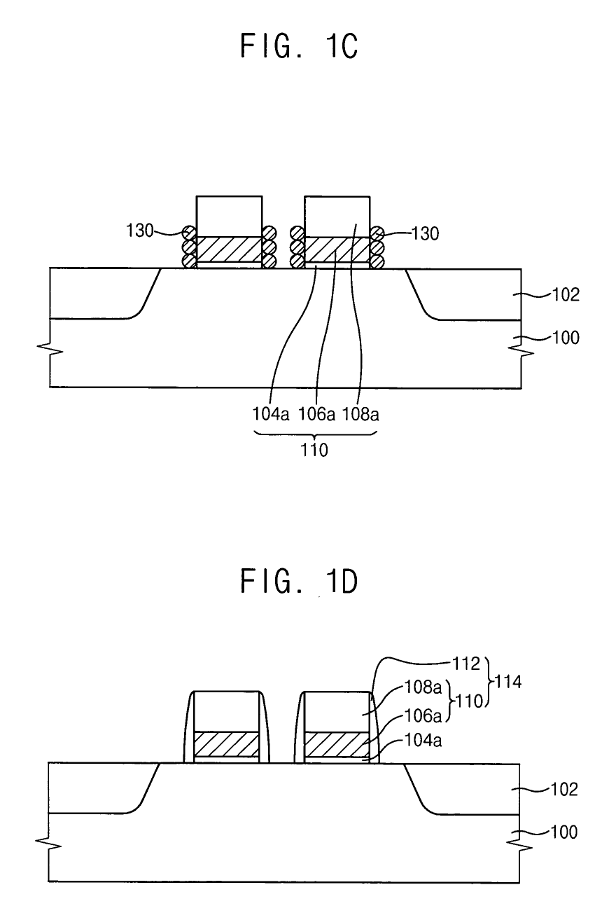

Methods of cleaning metal layers on semiconductor substrates include cleaning tungsten-based gate electrodes. As illustrated by FIG. 1A, these methods include forming a gate oxide layer 104 on a semiconductor substrate 100 having at least one semiconductor active region therein. This active region may be defined by a plurality of trench-based isolation regions 102, which may be formed using conventional shallow trench isolation (STI) techniques. A gate metal layer 106 is also formed on the gate oxide layer 104. This gate metal layer 106 may be formed as a blanket tungsten metal layer using a deposition technique such as chemical vapor deposition (CVD). A layer of electrically insulating capping material 108 (e.g., photoresist) is deposited on the gate metal layer 106. As illustrated by FIG. 1B, the layer of capping material 108 may be photolithographically patterned (e.g., using a photoresist layer (not shown)) and then used as an etching mask to define a plurality of gate patterns 110. Each of these gate patterns 110 is illustrated as including a patterned gate oxide 104a, a patterned metal gate electrode 106a and a patterned capping layer 108a. During these steps, including photoresist removal (e.g., by plasma ashing), polymer and other residues 120 may be formed on the sidewalls of the gate patterns 110 and on other exposed surfaces. As described more fully herein, these residues 120 may be removed using a cleaning solution that contains a plurality of etchants and at least one corrosion-inhibiting agent that operates to protect exposed sidewalls of the patterned metal gate electrodes 106a. As illustrated by FIG. 1C, the corrosion-inhibiting agents 130 within the cleaning solution may chelate with the exposed sidewalls of the patterned metal gate electrodes 106a and thereby inhibit chemical reaction between the exposed sidewalls and etchants within the cleaning solution. The cleaning step can be followed by a rinsing step, which removes any remaining residues and inhibiting agents 130 from the substrate 100. Electrically insulating sidewall spacers 112 may then be formed on the gate patterns 110, to thereby define a plurality of insulated gate electrodes 114 as illustrated by FIG. 1D. These sidewall spacers 112 may be formed by depositing and etching-back an electrically insulating layer using conventional techniques.

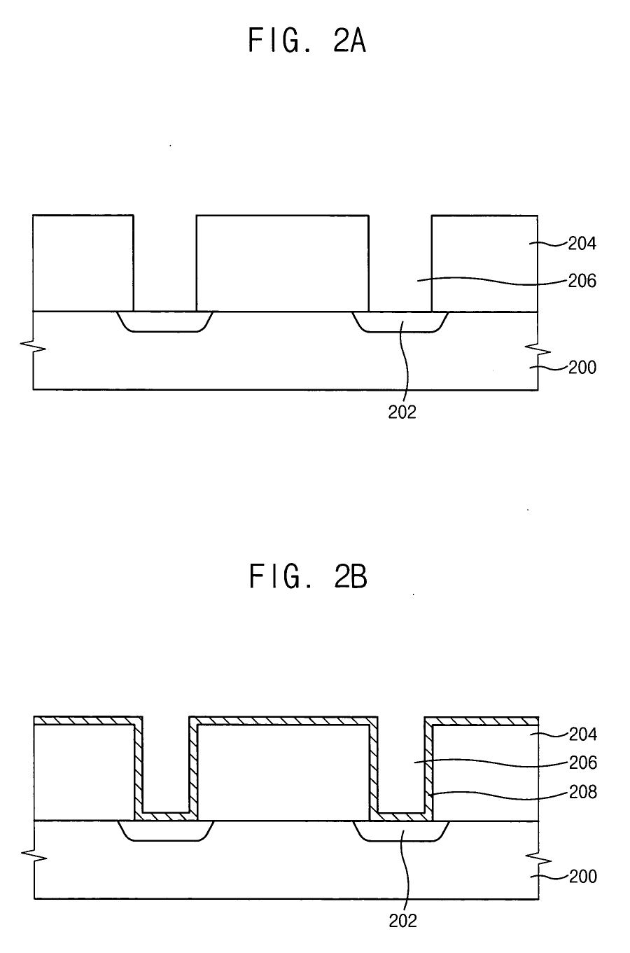

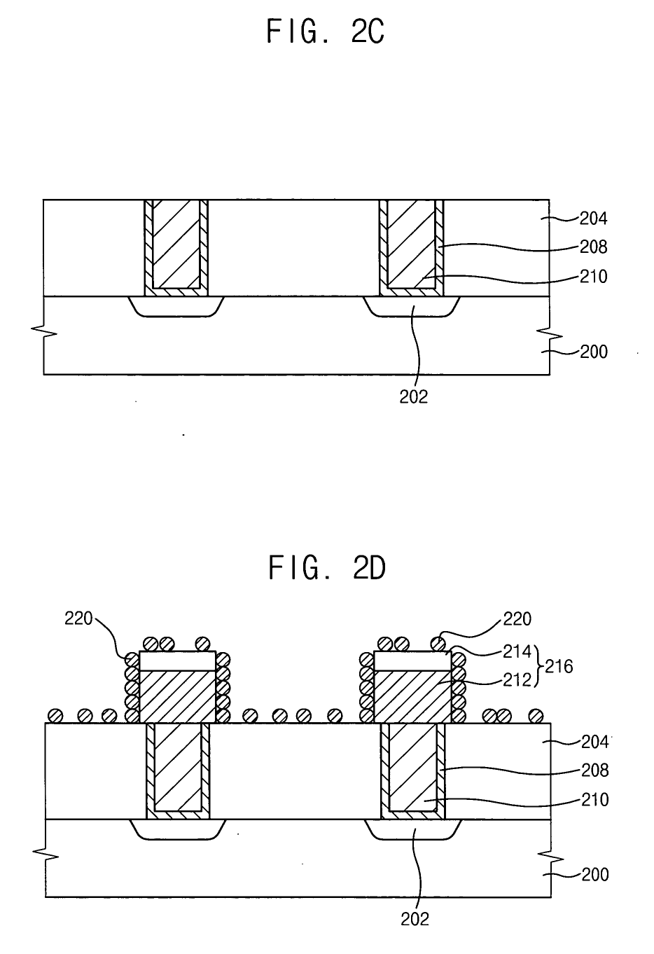

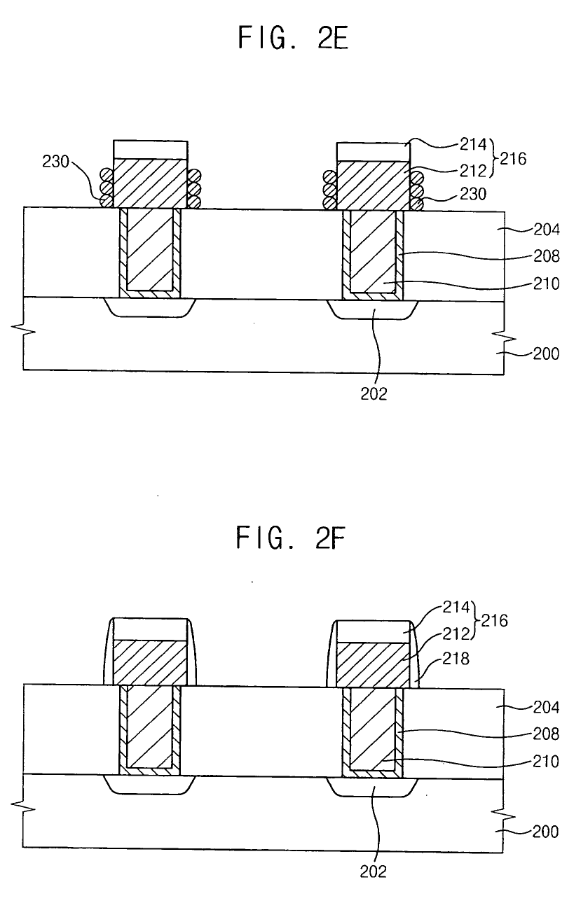

Additional methods of cleaning metal layers on semiconductor substrates may also include cleaning metal-based bit lines in semiconductor memory devices. As illustrated by FIG. 2A, these methods include forming an interlayer dielectric layer 204 on a semiconductor substrate 200. Although not shown, this interlayer dielectric layer 204 may be formed after the insulated gate electrodes 114 of FIG. 1D are formed on the substrate 200. The interlayer dielectric layer 204 is then patterned to define a plurality of contact holes 206 that expose respective diffusion regions 202 (e.g., source/drain and contact regions) within the substrate 200. Conventional techniques may then be used to conformally deposit a barrier metal layer 208 on the patterned interlayer dielectric layer 204. This barrier metal layer 208 may be a titanium layer (Ti), a titanium nitride layer (TiN) or a titanium/titanium nitride composite layer, for example. An electrically conductive layer (e.g., aluminum (Al) or tungsten (W)) is then deposited on the barrier metal layer 208. This electrically conductive layer is deposited to a sufficient thickness to fill the contact holes 206. A chemical-mechanical polishing (CMP) step may then be performed on the electrically conductive layer to thereby define a plurality of conductive plugs 210 within the contact holes 206. This CMP step may include the use of a slurry composition having the corrosion-inhibiting characteristics described herein with respect to the cleaning solutions. As illustrated by FIG. 2C, this polishing step is performed for a sufficient duration to expose a planarized interlayer dielectric layer 204. Referring now to FIG. 2D, a plurality of bit line nodes 216 may be formed on respective ones of the conductive plugs 210. These bit line nodes 216 may be formed by sequentially depositing a bit line metal layer 212 and a bit line capping layer 214 on the interlayer dielectric layer 204 and then patterning these layers into separate bit line nodes 216. As illustrated, this patterning step may result in the formation of polymer and other residues 220 on the exposed surfaces of the patterned layers. These residues 220 may be removed using a cleaning solution that contains a plurality of etchants and at least one corrosion-inhibiting agent that operates to protect exposed sidewalls of the bit line nodes 216. As illustrated by FIG. 2E, the corrosion-inhibiting agents 230 within the cleaning solution may chelate with the exposed sidewalls of the bit line nodes 216 and thereby inhibit chemical reaction between these exposed sidewalls and etchants within the cleaning solution. As illustrated by FIG. 2F, the cleaning step can be followed by a rinsing step, which removes any remaining residues 220 and inhibiting agents 230 from the substrate 200. Electrically insulating bit line spacers 218 may then be formed on the bit line nodes 216, to thereby define a plurality of insulated bit lines. These sidewall spacers 218 may be formed by depositing and etching-back an electrically insulating dielectric layer (e.g., SiO₂ layer) using conventional techniques.

The above-described corrosion-inhibiting cleaning solutions include an aqueous admixture of at least one metal etchant, first and second different oxide etchants, an azole and deionized water. The azole acts as a chelating agent that binds with and inhibits corrosion of metal layers (e.g., tungsten metal layers) being cleaned. The azole may be selected from a group consisting of triazole, benzotriazole, imidazole, tetrazole, thiazole, oxazole and pyrazole and combinations thereof. More preferably, the azole is either triazole, benzotriazole or imidazole. A quantity of the azole in the aqueous admixture is in a range from about 0.1 wt % to about 5 wt %. In some embodiments of the present invention, the first oxide etchant is sulfuric acid (H₂SO₄) and the second oxide etchant is a fluoride. The fluoride may be hydrogen fluoride, ammonium fluoride, tetramethyammonium fluoride, ammonium hydrogen fluoride, fluroroboric acid and tetramethylammonium tetrafluoroborate. The metal etchant is a peroxide. The peroxide may be hydrogen peroxide, ozone, peroxosulfuric acid, peroxoboratic acid, peroxophosphoric acid, peracetic acid, perbenzoic acid and perphthalic acid. A quantity of the metal etchant in the aqueous admixture is in a range from about 0.5 wt % to about 5 wt %. This level of metal etchant is sufficient to have good metal polymer removal rate but not too high to provide metal layer over-etch. A quantity of the sulfuric acid in the aqueous admixture may also be set within a range from about 1 wt % to about 10 wt % and a quantity of the fluoride in the aqueous admixture may be set within a range from about 0.01 wt % to about 1 wt %. TABLE 1 illustrates the compositions in a plurality of example cleaning solutions containing equal amounts of sulfuric acid (H₂SO₄), hydrogen peroxide (H₂O₂) and hydrogen fluoride (HF), with different quantities of deionized water (H₂O) and different quantities of different azole compounds. In particular, example solutions 1-5 contain triazole, examples 6-10 contain benzotriazole and example solutions 11-15 contain imidazole. Example solutions 16-18 contain tetrazole, thiazole and oxazole, respectively. The constituents of a comparison cleaning solution (Comparison 1), which contains no azole compound, is also illustrated by TABLE 1.

TABLE 1

| | H2SO4 | H202 | HF | H20 | CORROSION INHIBITOR | INHIBITOR WEIGHT |
|---|---|---|---|---|---|---|
| EXAMPLE 1 | 5 | 2.5 | 0.05 | 92.35 | (TRIAZOLE) | 0.1 |
| EXAMPLE 2 | 5 | 2.5 | 0.05 | 91.45 | | 1 |
| EXAMPLE 3 | 5 | 2.5 | 0.05 | 90.45 | | 2 |
| EXAMPLE 4 | 5 | 2.5 | 0.05 | 87.45 | | 5 |
| EXAMPLE 5 | 5 | 2.5 | 0.05 | 82.45 | | 10 |
| EXAMPLE 6 | 5 | 2.5 | 0.05 | 92.35 | (BENZOTRIAZOLE) | 0.1 |
| EXAMPLE 7 | 5 | 2.5 | 0.05 | 91.45 | | 1 |
| EXAMPLE 8 | 5 | 2.5 | 0.05 | 90.45 | | 2 |
| EXAMPLE 9 | 5 | 2.5 | 0.05 | 87.45 | | 5 |
| EXAMPLE 10 | 5 | 2.5 | 0.05 | 82.45 | | 10 |
| EXAMPLE 11 | 5 | 2.5 | 0.05 | 92.35 | (IMIDAZOLE) | 0.1 |
| EXAMPLE 12 | 5 | 2.5 | 0.05 | 91.45 | | 1 |
| EXAMPLE 13 | 5 | 2.5 | 0.05 | 90.45 | | 2 |
| EXAMPLE 14 | 5 | 2.5 | 0.05 | 87.45 | | 5 |
| EXAMPLE 15 | 5 | 2.5 | 0.05 | 82.45 | | 10 |
| EXAMPLE 16 | 5 | 2.5 | 0.05 | 90.45 | (TETRAZOLE) | 2 |
| EXAMPLE 17 | 5 | 2.5 | 0.05 | 90.45 | (THIAZOLE) | 2 |
| EXAMPLE 18 | 5 | 2.5 | 0.05 | 90.45 | (OXAZOLE) | 2 |
| COMPARE 1 | 5 | 2.5 | 0.05 | 92.45 | — | — |

TABLE 2 illustrates the BPSG (borophosphosilicate glass) etch rates that were achieved with a plurality of the cleaning solutions illustrated by TABLE 1. In particular, TABLE 2 illustrates a highest oxide etch rate for the comparison solution (Compare 1), which contains no corrosion-inhibiting agent. TABLE 2 also illustrates how higher concentrations of the corrosion-inhibiting agent (triazole, benzotriazole and imidazole) result in lower oxide etch rates. For example, the oxide etch rate using the 3^{rd} example solution (2 wt % triazole) is less than the oxide etch rate for 1^{st} example solution (0.1 wt % triazole); the oxide etch rate for the 8^{th} example solution (2 wt % benzotriazole) is less than the oxide etch rate for the 6^{th} example solution (0.1 wt % benzotriazole); and the oxide etch rate for the 13^{th} example solution (2 wt % imidazole) is less than the oxide etch rate for the 11^{th} example solution (0.1 wt % imidazole).

TABLE 2

| | | | | | | EX- | |
|---|---|---|---|---|---|---|---|
| | | | | | EXAM- | AM- | |
| | EXAM- | EXAM- | EXAM- | EXAM- | PLE | PLE | COM- |
| | PLE 1 | PLE 3 | PLE 6 | PLE 8 | 11 | 13 | PARE 1 |
| BPSG | 66 | 48 | 77 | 59 | 78 | 52 | 111 |
| ETCH | | | | | | | |
| RATE | | | | | | | |
| (Å/10 | | | | | | | |
| min) | | | | | | | |

TABLE 3 illustrates the cleaning ability of a plurality of the cleaning solutions illustrated by TABLE 1. In particular, TABLE 3 illustrates better cleaning ability for example solutions 3, 8 and 13, which include 2 wt % of a respective azole compound, relative to example solutions 1, 6 and 11, which only include 0.1 wt % of an azole compound. TABLE 3 also illustrates that poor cleaning ability is present in the comparison solution (Compare 1), which is devoid of an azole compound.

TABLE 3

| | EXAMPLE 1 | EXAMPLE 3 | EXAMPLE 6 | EXAMPLE 8 | EXAMPLE 11 | EXAMPLE 13 | COMPARE 1 |
|---|---|---|---|---|---|---|---|
| CLEANING | GOOD | EXCELLENT | GOOD | EXCELLENT | GOOD | EXCELLENT | BAD |
| ABILITY | | | | | | | |

TABLE 4 illustrates the tungsten etch rates associated with the cleaning solutions illustrated by TABLE 1. In particular, TABLE 4 illustrates that for a given one of the most preferred azole compounds (triazole, benzotriazole and imidazole), the tungsten etch rate decreases (to some saturated level) as the quantity of azole compound is increased. TABLE 4 also illustrates a highest tungsten etch rate for the comparison solution (Compare 1), which is devoid of an azole compound.

TABLE 4

| | | EXAMPLE | EXAMPLE | EXAMPLE | EXAMPLE | EXAMPLE | EXAMPLE | EXAMPLE |
|---|---|---|---|---|---|---|---|---|
| | EXAMPLE 1 | 2 | 3 | 4 | 5 | 6 | 7 | 8 |
| TUNGSTEN ETCH | 57 | 34 | 27 | 24 | 23 | 72 | 57 | 45 |
| RATE (Å/10 min) | | | | | | | | |
| | | EXAMPLE | EXAMPLE | EXAMPLE | EXAMPLE | EXAMPLE | EXAMPLE | COMPARE |
| | EXAMPLE 9 | 10 | 11 | 12 | 13 | 14 | 15 | 1 |
| TUNGSTEN ETCH | 35 | 36 | 69 | 52 | 33 | 35 | 32 | 78 |
| RATE (Å/10 min) | | | | | | | | |

Analysis of additional example solutions demonstrates that using less than 0.01 wt % of the corrosion-inhibiting agent (azole) results in poor corrosion inhibition and that a degree of corrosion inhibition saturates at levels greater than about 10 wt %. A more preferred range for the corrosion-inhibiting agent extends from about 0.1 wt % to about 5 wt %. This analysis also demonstrates that using less than 0.05 wt % of peroxide results in poor polymer removal ability and using greater than 10 wt % of peroxide results in metal layer over-etch. A more preferred range for the peroxide extends from about 0.5 wt % of about 5 wt %. The analysis further demonstrates that using less than 0.001 wt % of fluoride results in poor oxide polymer removal ability and using greater than 2 wt % of fluoride results in oxide layer over-etch and lifting of metal patterns. A more preferred range for the fluoride extends from about 0.01 wt % to about 1 wt %.

In the drawings and specification, there have been disclosed typical preferred embodiments of the invention and, although specific terms are employed, they are used in a generic and descriptive sense only and not for purposes of limitation, the scope of the invention being set forth in the following claims.

1. A corrosion-inhibiting cleaning composition for semiconductor wafer processing, comprising an aqueous admixture of at least a metal etchant, first and second oxide etchants, an azole and water.

2. The cleaning composition of claim 1, wherein the azole is selected from a group consisting of triazole, benzotriazole and imidazole.

3. The cleaning composition of claim 1, wherein the first oxide etchant is sulfuric acid and the second oxide etchant is fluoride.

4. The cleaning composition of claim 1, wherein the metal etchant is a peroxide.

5. The cleaning composition of claim 1, wherein the metal etchant is a peroxide, the first oxide etchant is sulfuric acid, the second oxide etchant is fluoride and the azole is selected from a group consisting of triazole, benzotriazole and imidazole.

6. The cleaning composition of claim 5, wherein a quantity of the metal etchant in the aqueous admixture is in a range from about 0.5 wt % to about 5 wt %; wherein a quantity of the sulfuric acid in the aqueous admixture is in a range from about 1 wt % to about 10 wt %; wherein a quantity of the fluoride in the aqueous admixture is in a range from about 0.01 wt % to about 1 wt %; and wherein a quantity of the azole in the aqueous admixture is in a range from about 0.1 wt % to about 5 wt %.

7. A corrosion-inhibiting cleaning solution for semiconductor wafer processing, consisting essentially of a peroxide at a concentration in a range from about 0.5 wt % to about 5 wt %, sulfuric acid at a concentration in a range from about 1 wt % to about 10 wt %, a fluoride at a concentration in a range from about 0.01 wt % to about 1 wt %; an azole at a concentration in a range from about 0.1 wt % to about 5 wt % and deionized water.

8. The cleaning solution of claim 7, wherein the azole is selected from a group consisting of triazole, benzotriazole, imidazole, tetrazole, thiazole, oxazole and pyrazole and combinations thereof.

9. The cleaning solution of claim 7, wherein the fluoride compound is hydrogen fluoride.

10. The cleaning solution of claim 7, wherein the peroxide is hydrogen peroxide.

11. A corrosion-inhibiting cleaning solution for semiconductor wafer processing, consisting essentially of a metal etchant, first and second oxide etchants, an azole and water.

12. The cleaning solution of claim 11, wherein the azole is selected from a group consisting of triazole, benzotriazole and imidazole.

13. The cleaning solution of claim 11, wherein the first oxide etchant is sulfuric acid and the second oxide etchant is fluoride.

14. The cleaning solution of claim 11, wherein the metal etchant is a peroxide.

15. The cleaning solution of claim 11, wherein the metal etchant is a peroxide, the first oxide etchant is sulfuric acid, the second oxide etchant is fluoride and the azole is selected from a group consisting of triazole, benzotriazole and imidazole.

16. The cleaning solution of claim 15, wherein a quantity of the metal etchant in the aqueous admixture is in a range from about 0.5 wt % to about 5 wt %; wherein a quantity of the sulfuric acid in the aqueous admixture is in a range from about 1 wt % to about 10 wt %; wherein a quantity of the fluoride in the aqueous admixture is in a range from about 0.01 wt % to about 1 wt %; and wherein a quantity of the azole in the aqueous admixture is in a range from about 0.1 wt % to about 5 wt %.

17. A corrosion-inhibiting cleaning solution for semiconductor wafer processing, consisting essentially of hydrogen peroxide, sulfuric acid, hydrogen fluoride, an azole and water.

18. The cleaning solution of claim 11, wherein the azole is selected from a group consisting of triazole, benzotriazole and imidazole.

19. A corrosion-inhibiting cleaning solution for semiconductor wafer processing, consisting essentially of hydrogen peroxide at a concentration in a range from about 0.5 wt % to about 5 wt %, sulfuric acid at a concentration in a range from about 1 wt % to about 10 wt %, hydrogen fluoride at a concentration in a range from about 0.01 wt % to about 1 wt %; a tungsten chelating agent at a concentration in a range from about 0.1 wt % to about 5 wt % and deionized water.

20. A method of forming an integrated circuit device, comprising the steps of:
forming a gate oxide layer on an integrated circuit substrate;
forming a tungsten metal layer on the gate oxide layer;
patterning the tungsten metal layer and gate oxide layer to define a tungsten-based insulated gate electrode; and
exposing the patterned tungsten metal layer to a cleaning solution comprising a metal etchant, at least first and second oxide etchants, an azole and deionized water.

21. The method of claim 20, wherein said exposing step comprises exposing the patterned tungsten metal layer to a cleaning solution comprising a metal etchant at a concentration in a range from about 0.5 wt % to about 5 wt %, a first oxide etchant at a concentration in a range from about 1 wt % to about 10 wt %, a second oxide etchant at a concentration in a range from about 0.01 wt % to about 1 wt %, an azole at a concentration in a range from about 0.1 wt % to about 5 wt %, and deionized water.

22. The method of claim 21, wherein the metal etchant is a peroxide, the first oxide etchant is sulfuric acid and the second oxide etchant is a fluoride.

23. The method of claim 20, wherein said exposing step comprises exposing the patterned tungsten metal layer to a cleaning solution consisting essentially of a metal etchant at a concentration in a range from about 0.5 wt % to about 5 wt %, a first oxide etchant at a concentration in a range from about 1 wt % to about 10 wt %, a second oxide etchant at a concentration in a range from about 0.01 wt % to about 1 wt %, an azole at a concentration in a range from about 0.1 wt % to about 5 wt %, and deionized water.

24. The method of claim 21, wherein the metal etchant is hydrogen peroxide, the first oxide etchant is sulfuric acid and the second oxide etchant is hydrogen fluoride.

25. The method of claim 23, wherein the metal etchant is hydrogen peroxide, the first oxide etchant is sulfuric acid and the second oxide etchant is hydrogen fluoride.

26. A method of forming a memory device, comprising the steps of:
forming an interlayer dielectric layer on an integrated circuit substrate;
forming an interconnect opening in the interlayer dielectric layer;
filling the interconnect opening with a conductive plug;
forming a bit line node electrically coupled to the conductive plug;
exposing the bit line node to a cleaning solution comprising a metal etchant, at least first and second oxide etchants, an azole and deionized water.

27. The method of claim 26, wherein said exposing step comprises exposing the patterned tungsten metal layer to a cleaning solution comprising a metal etchant at a concentration in a range from about 0.5 wt % to about 5 wt %, a first oxide etchant at a concentration in a range from about 1 wt % to about 10 wt %, a second oxide etchant at a concentration in a range from about 0.01 wt % to about 1 wt %, an azole at a concentration in a range from about 0.1 wt % to about 5 wt %, and deionized water.

28. The method of claim 27, wherein the metal etchant is a peroxide, the first oxide etchant is sulfuric acid and the second oxide etchant is a fluoride.

29. The method of claim 26, wherein said exposing step comprises exposing the patterned tungsten metal layer to a cleaning solution consisting essentially of a metal etchant at a concentration in a range from about 0.5 wt % to about 5 wt %, a first oxide etchant at a concentration in a range from about 1 wt % to about 10 wt %, a second oxide etchant at a concentration in a range from about 0.01 wt % to about 1 wt %, an azole at a concentration in a range from about 0.1 wt % to about 5 wt %, and deionized water.

30. The method of claim 27, wherein the metal etchant is hydrogen peroxide, the first oxide etchant is sulfuric acid and the second oxide etchant is hydrogen fluoride.

31. The method of claim 29, wherein the metal etchant is hydrogen peroxide, the first oxide etchant is sulfuric acid and the second oxide etchant is hydrogen fluoride.

32. A slurry precursor composition for chemical-mechanical polishing of metal layers on semiconductor substrates, comprising:
an aqueous admixture containing a metal etchant, first and second oxide etchants, an abrasive, an azole and water.

33. The slurry precursor composition of claim 32, wherein the metal etchant is a peroxide, the first oxide etchant is sulfuric acid, the second oxide etchant is fluoride and the azole is selected from a group consisting of triazole, benzotriazole and imidazole.
